(19) United States
(12) Patent Application Publication
(10) Pub. No.: US 2008/0166678 A1
(43) Pub. Date: Jul. 10, 2008

(54) Removable intraoral lighting device

(76) Inventors: Or Ramot, Givat-Shmuel (IL); Israel Ramot, Kfar-Saba (IL); Zvi Davidovic, Ramat-Gan (IL)

Correspondence Address: Dr. D. Graeser Ltd.;c/o The Discovery Dispatch, 9003 Florin Way, Upper Marlboro, MD, 20772, US

(21) Appl. No.: 11/882,952

(22) Filed: Aug. 8, 2007

Related U.S. Application Data
(60) Provisional application No. 60/883,349, filed on Jan. 4, 2007.

(51) Int. Cl. A61C 19/00

(52) U.S. Cl. 433/29

(57) ABSTRACT

A removable intraoral lighting device which can be assembled to many various kinds of dental tools, including a main assembly, containing a miniature and powerful light source, fed from an electric power supply. The main assembly has an external geometrical structure which enables connection to a dental tool, such as a saliva suction device. The removable intraoral lighting device can also include one or more clips for clipping an electrical wire, if necessary, to the dental tool. The scope of the invention includes a method of connecting the removable intraoral lighting device to the dental tool, freeing the dentist's and the dental assistant's hands, and using it as an internal source of lighting a patient's oral cavity during dental treatment.

### REFERENCE TO CROSS-RELATED APPLICATION

This application claims the benefit of U.S. Provisional Patent Application No. 60/883,349 filed Jan. 4, 2007, which is hereby incorporated by reference as if fully set forth herein.

### FIELD OF THE INVENTION

The present invention relates to a removable intraoral lighting device and, in particular to a removable intraoral lighting device which can be assembled to and/or combined with many kinds of dental tools.

### BACKGROUND OF THE INVENTION

In almost all dental treatments dentists and dental practitioners have a need for strong light sources. One can find various existing illumination solutions such as a light source on the dental unit, a forehead projector light source, and a light source on some unique tools.

All have major drawbacks. Extraoral light sources such as a light source on the dental unit and a forehead projector light source cause reflection from the enamel of the teeth, which can have a temporarily blinding effect on the dentist.

Furthermore, distant light sources consume a more considerable amount of power, also generating unwanted heat, when compared to a proximal light source.

Also the dental practitioner's hands and tools may frequently block the illumination, thus specifically shading the treated areas. Light sources of unique tools such as high speed drills, which are equipped with a light source, are useful, but only for certain actions, in this case drilling.

A dental hand instrument with incorporated light source is described in U.S. Pat. No. 6,030,210 of Bianchetti, which is incorporated by reference for all purposes as if fully set forth herein.

FIG. 1 of the prior art illustrates a surgical instrument 100 employed by dentists for scaling and removing tartar and plaque from the tooth surface, provided with a light source 11 for illuminating the working area in the patient's oral cavity. The surgical instrument 100 is equipped with a vibrating workpiece 12, and is designated for performing dental surgery procedures.

Like the disadvantages listed above, the main drawback of the surgical instrument 100 is in that it only enables illumination of the oral cavity when the instrument is in use, and it cannot provide illumination of the oral cavity for use of other common tools, such as a drill. Furthermore, due to its unique structure, the light is dispersed as a very narrow beam, and it does not provide sufficient lighting of the oral cavity.

### SUMMARY OF THE INVENTION

The background art does not teach or suggest a removable intraoral lighting device, which can, in one or more configurations, be assembled to many various kinds of dental tools.

The present invention overcomes these deficiencies of the background art by providing a removable intraoral lighting device and, in particular a removable intraoral lighting device which can be assembled to many various kinds of dental tools.

Additional objects and advantages of the invention will be set forth in part in the description which follows and, in part, will be obvious from the description, or may be learned by practice of the invention.

An embodiment of the present invention is described herein below in which a double high intensity light emitting diode (LED) is located on a saliva suction device, however use of a single LED or a larger array of LED's or other suitable light sources may be applied. In this first embodiment, both LED's are located on a board made of material which is commonly used for printed circuit boards (PCB's) in the electronic and computer industries.

The PCB carrying the LED's is disposed within a case, which is composed of two parts, in this embodiment: a rear housing and a front housing, with holes for enabling the projection of light from the light sources.

In other embodiments the case can be composed of a single part, or of more than two parts, and each light source can optionally be covered with a lens or a transparent window.

A wire, preferably a thin insulated wire, connects the light source to an external power supply (not shown in the figures). The external geometrical form of the case is suitable for assembly to the dental tool, in this specific embodiment to the saliva suction device.

All of the components described so far, other than wire and external power supply, are preferably included in the main assembly of the removable intraoral lighting device.

The removable intraoral lighting device can, in addition to the main assembly, the wire, and the external power supply, optionally also include one or more clips for attaching the wire to the saliva suction device.

Heat generated from the light sources can be removed by means of several methods, according to the present invention, including but not limited to one or more cooling fins, a PCB board frame, thermal pads, adhesives, and the flow of fluids within the attached dental tool, if there is any, such as in the saliva suction device and/or a combination thereof.

The structure and materials composing the removable intraoral lighting device according to the present invention can preferably be sterilized in the standard method of sterilization of dental utensils, namely they can withstand autoclave temperature.

Other embodiments and/or variations of the present invention include, but are not limited to:
The removable intraoral lighting device may optionally be attached to other elements such a dental suction device.
The removable intraoral lighting device may optionally be attached to a removable stand-alone piece within the mouth, for example connected in some manner to a tooth, to a device between the teeth designated for keeping the jaws open, or to a mouth curtain.
An internal power supply within the mouth, such as a small battery, may optionally be employed.
The removable intraoral lighting device may optionally be disposable or developed for one-time use.
The removable intraoral lighting device may optionally be autoclavable.
Any other suitable light source can optionally be used, additionally or alternatively, such as other solid state and/or miniature incandescent light sources for example.
The illumination color does not necessarily have to be white, for example, it may be ‘warm white’ or other colors.
The removable intraoral lighting device can include an adjustable mechanism for controlling light intensity.
The removable intraoral lighting device can include a light guide, for keeping the light source out of the mouth, and avoiding intraoral generation of heat.

Note that if the device is integrated in a tool such as a saliva suction device or a compressed air powered drill, air flow from suction or from a compressed air source can be alternatively or additionally optionally used to enhance cooling to the light sources, by providing forced convection cooling to the illuminator.

According to the present invention there is provided a removable intraoral lighting device including: (a) a main assembly enabling easy and strong clipping to a dental tool and for easy removal from the dental tool, the main assembly including: (i) a front housing having at least one light hole; (ii) a rear housing securely connected to the front housing; (iii) a board disposed among the front housing and rear housing; and (iv) at least one light source disposed upon the board, wherein an emitted light from the light source can pass through the light hole.

According to further features in the described embodiment the removable intraoral lighting device further including: (b) a wire operatively connected to the light source, enabling supply of electrical power from a power source.

According to still further features in the described embodiments the removable intraoral lighting device further including: (c) a wire sleeve securely connected to the rear housing, wherein the wire is disposed inside the wire sleeve.

According to still further features in the described embodiments the removable intraoral lighting device further including: (c) a clip disposed on the wire, the clip enabling easy and strong clipping to the dental tool and easy removal from the dental tool.

According to still further features in the described embodiments the front housing has at least one adhesive hole.

According to still further features in the described embodiments the removable intraoral lighting device further including: (b) at least one clipping element mounted on the rear housing.

According to still further features in the described embodiments the removable intraoral lighting device further including: (b) a board frame mounted on the board for adding strength to the board and for heat dispersal.

According to still further features in the described embodiments the rear housing has at lest one fin for adding strength to the board and for heat dispersal.

According to still further features in the described embodiments the removable intraoral lighting device further including: (b) at least one screw, wherein the screw fastens the rear housing to the front housing.

According to still further features in the described embodiments the removable intraoral lighting device further including: (b) at least one thermal pad disposed at the board, for heat dispersal.

According to further features in the described embodiments the removable intraoral lighting device further including: (ii) at least one screw hole.

According to still further features in the described embodiments the removable intraoral lighting device further including: (iii) at least one adhesive hole.

According to further features in the described embodiments the removable intraoral lighting device further including: (ii) a board frame.

According to still further features in the described embodiments the board is made of a PCB material.

According to still further features in the described embodiments the light source is a LED.

According to still further features in the described embodiments the removable intraoral lighting device including at least two LEDs.

According to the present invention there is provided a removable intraoral lighting device including: (a) a main assembly enabling easy and strong clipping to a dental tool and for easy removal from the dental tool, the main assembly including: (i) a front housing having at least one light hole; (ii) a rear housing securely connected to the front housing; (iii) a board disposed between the front housing and rear housing; and (iv) at least one light source disposed upon the board, wherein an emitted light from the light source can pass through the light hole; (b) a wire operatively connected to the light source, enabling supply of electrical power from a power source; (c) a wire sleeve securely connected to the rear housing, wherein the wire is disposed inside the wire sleeve; (d) at least one clip disposed at the wire, the clip enabling easy and strong clipping to the dental tool and easy removal from the dental tool; (e) at least one clipping element mounted on the rear housing; (f) a board frame mounted on the board for adding strength to the board and for heat dispersal; (g) at least one screw, wherein the screw fastens the rear housing to the front housing; and (h) at least one thermal pad disposed at the board, for heat dispersal; wherein the front housing has at least one adhesive hole, and wherein the rear housing has at least one fin for adding strength to the board and for heat dispersal.

According to further features in the described embodiment the dental tool is a saliva suction device.

According to further features in the described embodiment the dental tool is a drill.

According to further features in the described embodiment the dental tool is a suction tube.

According to the present invention there is provided a method of using removable intraoral lighting device providing effective light in the oral cavity while a dentist performs a treatment procedure, the method including the stages of: (a) providing a dental tool; (b) providing a removable intraoral lighting device; and (c) connecting the removable intraoral lighting device to the dental tools.

According to further features in the described embodiments the method further including the stages of: (d) inserting the dental tool into the patient's mouth; (e) activating the light of the removable intraoral lighting device; and (f) performance of the treatment procedure by the dentist.

According to still further features in the described embodiments the method further including the stages of: (g) deactivating of the light; (h) removing the dental tool from the patient's mouth; (i) separating the removable intraoral lighting device from the dental tool; and (j) disinfecting the removable intraoral lighting device.

(h) at least one thermal pad disposed at the board, for heat dispersal; wherein the front housing has at least one adhesive hole, and wherein the rear housing has at lest one fin for adding strength to the board and for heat dispersal.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1 of the prior art illustrates a surgical instrument provided with a light source.

FIG. 2 is a perspective schematic illustration of an exemplary, illustrative embodiment of a removable intraoral lighting device, according to the present invention, connected to a saliva suction device.

FIG. 3 is a front view schematic illustration of the main assembly of the above embodiment of the removable intraoral lighting device, according to the present invention.

FIG. 4a is a rear view schematic illustration of the main assembly of the above embodiment of the removable intraoral lighting device, according to the present invention.

FIG. 4b is a schematic cross sectional view of a cooling pin according to the present invention.

FIG. 5 is a top view schematic illustration of the main assembly of the above embodiment of the removable intraoral lighting device, according to the present invention.

FIG. 6 is a side view schematic illustration of the main assembly of the first embodiment of the removable intraoral lighting device, according to the present invention.

FIG. 7 is a rear perspective view schematic illustration of the main assembly of the above embodiment of the removable intraoral lighting device, connected to the saliva suction device, according to the present invention.

FIG. 8 is a rear perspective view schematic illustration of the main assembly of the above embodiment of the removable intraoral lighting device, according to the present invention.

FIG. 9 is a perspective exploded view schematic illustration of the main assembly of the above embodiment of the removable intraoral lighting device, according to the present invention.

FIG. 10 is a perspective schematic illustration of another exemplary, illustrative embodiment of a removable intraoral lighting device, according to the present invention, connected to a suction tube.

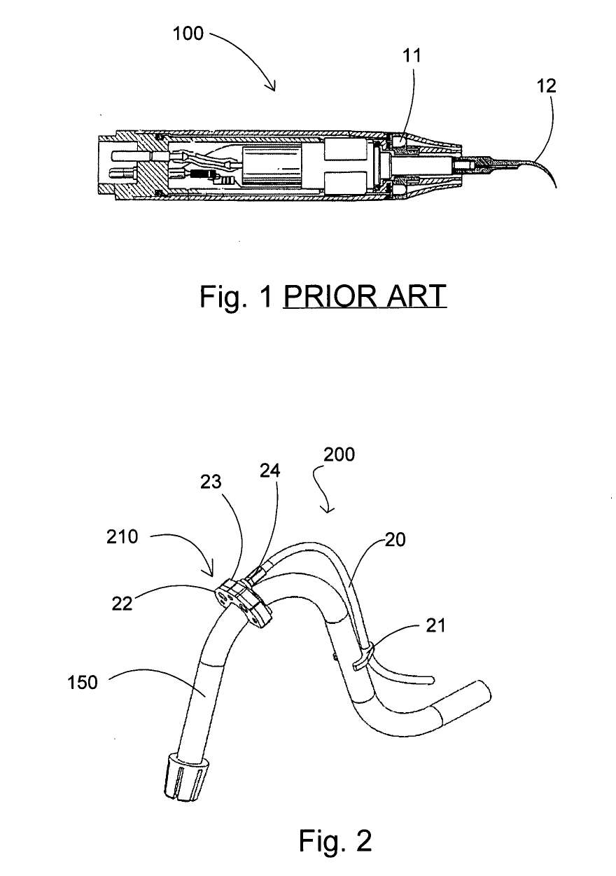

### DETAILED DESCRIPTION OF EMBODIMENTS

The present invention is of a removable intraoral lighting device and, in particular a removable intraoral lighting device for combination with and/or assembly to many kinds of dental tools.

The principles and operation of a removable intraoral lighting device according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:
11 light source of the prior art surgical instrument
12 vibrating workpiece of the prior art surgical instrument
20 wire
21 clip
22 front housing
23 rear housing
24 wire sleeve
25 LED
26 screw hole
27 adhesive hole
28 clipping element
29 screw
30 fin
31 board
32 board frame
33 thermal pads
34 lens
35 transparent window
36 light hole
37 cooling pin
100 prior art surgical instrument
150 saliva suction device
151 suction tube
200 removable intraoral lighting device
210 main assembly of an embodiment
211 main assembly of another embodiment

Referring now to the drawings, FIG. 2 is a perspective schematic illustration of an illustrative, exemplary embodiment of a removable intraoral lighting device 200, according to the present invention, connected to the saliva suction device. This illustration shows the main components of the removable intraoral lighting device 200 as seen from outside. The removable intraoral lighting device 200 is shown to include main assembly 210, which is in this specific embodiment attached to saliva suction device 150, to which a wire 20 is connected, the connection of which can optionally and preferably be strengthened by wire sleeve 24. Main assembly 210 features a front housing 22 and a rear housing 23 as shown.

The illustration also shows clip 21, which can serve for connecting the wire 20 to the saliva suction device 150, in order not to interfere with the dentist's work.

The removable intraoral lighting device 200 can also include more than one clip 21.

Wire 20 may optionally be a conductor such as RG178 Teflon type as a non-limiting example. It is an element conducting electricity from a power unit (not shown) to the light source(s), preferably made of material(s) that can withstand autoclave temperature.

The wire sleeve 24 is an optional but preferred element which can preferably facilitate reduction of mechanical stress and strain from wire 20 connection to the board, which may for example optionally be a PCB (not shown in the present illustration). Any suitable material can optionally be used, additionally or alternatively, such as flexible PCB for example.

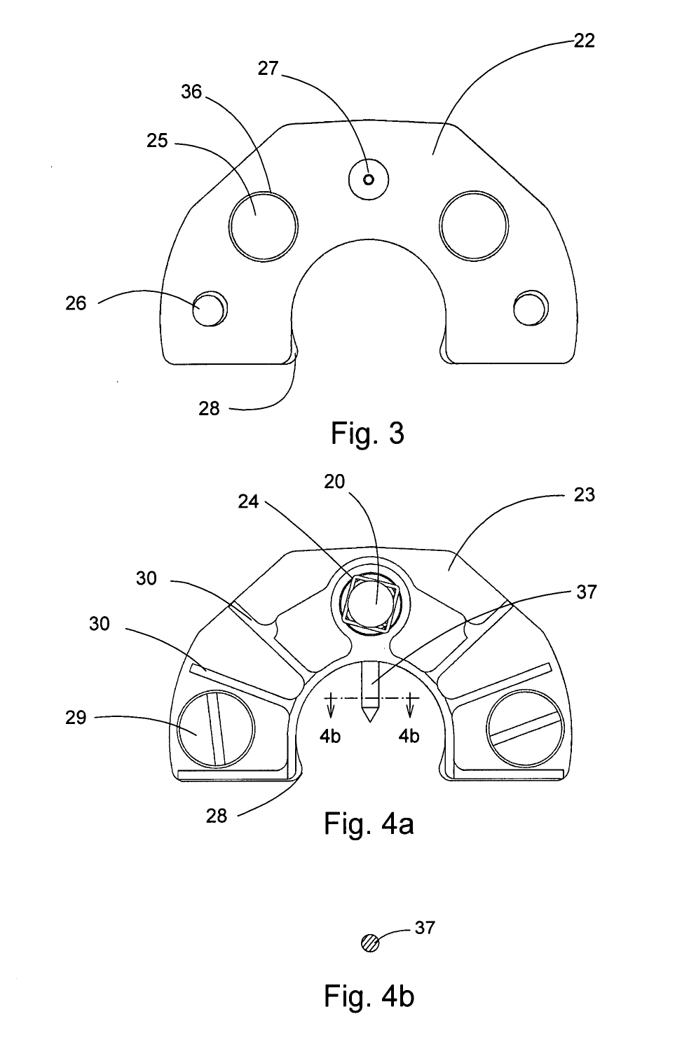

FIG. 3 is a front view schematic illustration of the main assembly 210 of the first embodiment of the removable intraoral lighting device 200, according to the present invention. The illustration shows the front housing 22 of the main assembly 210 (not shown in the present illustration). Front housing 22 preferably serves as front closure for a LED compartment, and as a part of a clip which enables clipping or attachment (preferably removable attachment) to the saliva suction device 150, (not shown in the present Figure). Front housing 22 includes at least one light hole 36, which can contain at least a part of the volume of the light source, and also enables projection of light, at least one adhesive hole 27 for inserting adhesive, and at least one screw hole 26 with thread for screws.

Other embodiments may optionally feature one or more other solutions, such as welding, pasting, attaching by force of friction, etc., which do not include screws, thus eliminating the need for holes for inserting screws.

Front housing 22 can be composed of a solid material, preferably with high thermal conductivity, such as aluminum and preferably a high enough CTE to withstand 130 degrees Centigrade, namely autoclaving heat and conditions.

The external geometrical shape of front housing 22 includes a socket which can serve, with or without an additional element, as a clipping element 28 for connection to, and removal from the saliva suction device 150.

FIG. 4a is a rear view schematic illustration of the main assembly 210 of the first embodiment of the removable intraoral lighting device 200, according to the present invention. The illustration shows the rear housing 23 of the main assembly 210, which serves as a rear closure for the LED compartment, and as a part of a clip which enables clipping to the saliva suction device 150. Rear housing 23 includes at least one hole (not shown in the present illustration) for inserting a screw 29, a hole (not shown in the illustration) for inserting wire sleeve 24, wire 20, and at least one fin 30 which can facilitate cooling and which strengthens the structure. Fin 30 can be made of any solid material, preferably with high thermal conductivity, such as aluminum and preferably a high enough CTE to withstand 130 degrees Centigrade, namely autoclaving heat and conditions.

The external geometrical shape of rear housing 23 includes a socket which can serve, with or without an additional element, as a clipping element 28 for connection to and removal from the saliva suction device 150.

The main assembly 210 can include a cooling pin 37, connected to the rear housing 23 as shown in the present illustration, however it can also be connected to the front housing 22. The cooling pin 37 is inserted into the dental tool, and facilitates cooling by conducting heat to the fluid flowing inside the tool. The illustration shows section line 4b-4b.

FIG. 4b is a schematic cross sectional view of a cooling pin 37 according to the present invention. The section is section 4b-4b shown in FIG. 4a.

Experiments show that the most efficient section shape for inserting into dental tools is a circular section.

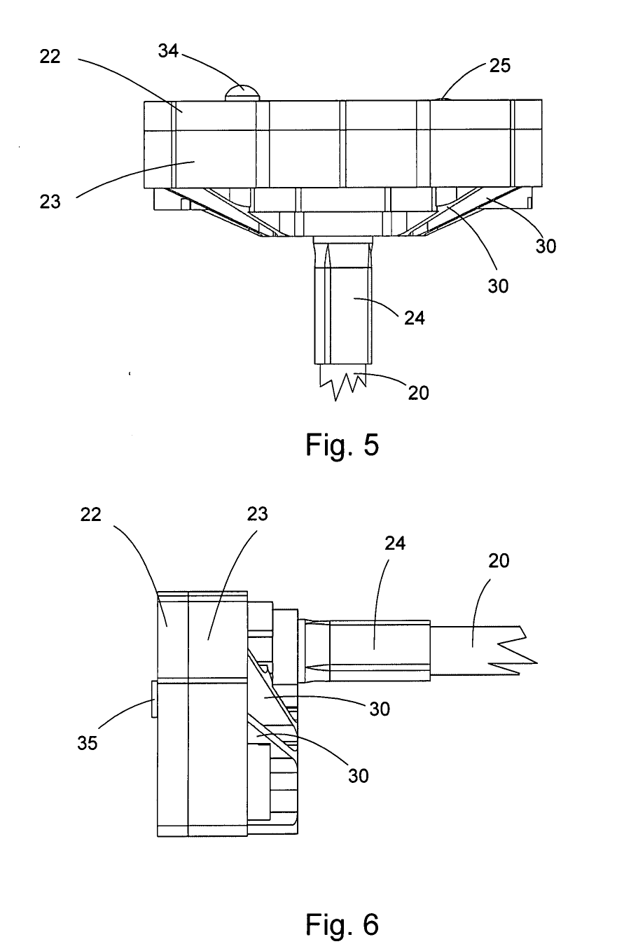

FIG. 5 is a top view schematic illustration of the main assembly 210 of the embodiment of the removable intraoral lighting device 200, according to the present invention. This illustration shows the light source 25, in this embodiment, a LED, front housing 22. As noted above, other embodiments can optionally include other types and other quantities of light sources, as well as optionally featuring a lens 34 which can protect the light source and affect the dispersal of light radiation from the source.

FIG. 6 is a side view schematic illustration of the main assembly 210 of the first embodiment of the removable intraoral lighting device 200, according to the present invention.

This illustration shows a suitable transparent window 35 for this and optionally other embodiments, which can protect the light source. The present illustration shows transparent window 35 preferably protruding slightly outwards from the front housing 22, however, transparent window 35 can also optionally and alternatively be embedded within the front housing 22 and both can together comprise a single flat, continuous surface.

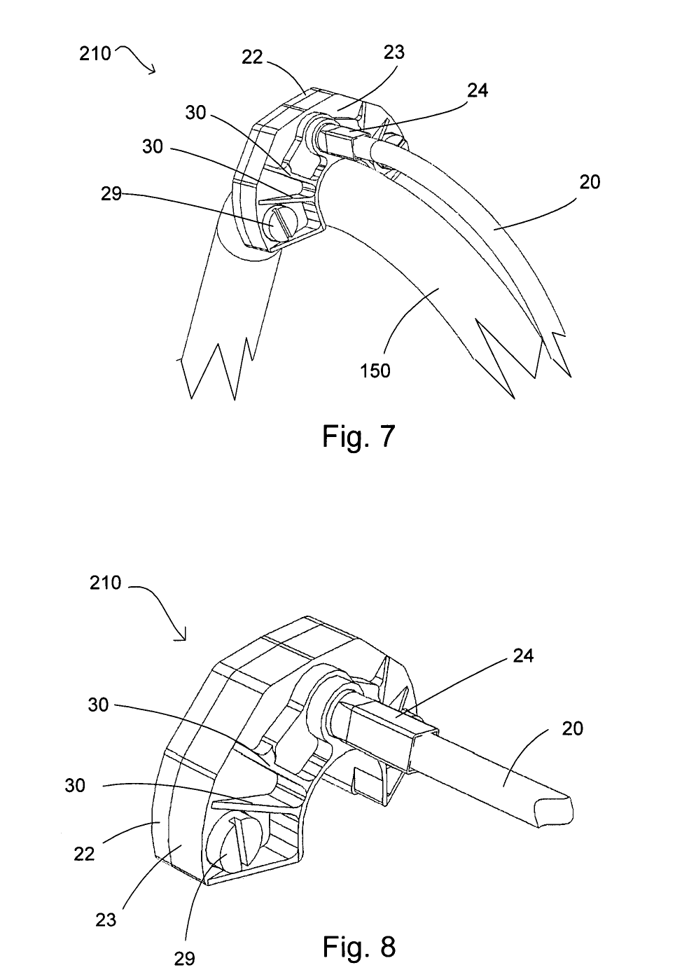

FIG. 7 is a rear perspective view schematic illustration of the main assembly 210 of the first embodiment of the removable intraoral lighting device 200, connected to the saliva suction device, according to the present invention.

This illustration also shows three-dimensional views of possible shapes of the fins 30, screws 29, and the wire sleeve 24. Screws 29 fasten the front housing 22, the rear housing 23, and the board 31 together.

FIG. 8 is a rear perspective view schematic illustration of the main assembly 210 of the first embodiment of the removable intraoral lighting device 200, according to the present invention. The illustration shows clipping element 28, designated to facilitate easy snap on (i.e. attachment) to and easy snap off (i.e. attachment) from the dental tool. The inner perimeter of the socket, shown in the illustration, is preferably slightly larger than 180 degrees, such that a small force applied on the removable intraoral lighting device, while connecting it to the dental tool, squeezes the dental tool and enables the dental tool to be inserted into the inner perimeter. Moreover, the inner diameter of the socket is preferably slightly smaller than the diameter of the dental tool in such a way that the removable intraoral lighting device is stable and cannot fall off or roll over due to gravity.

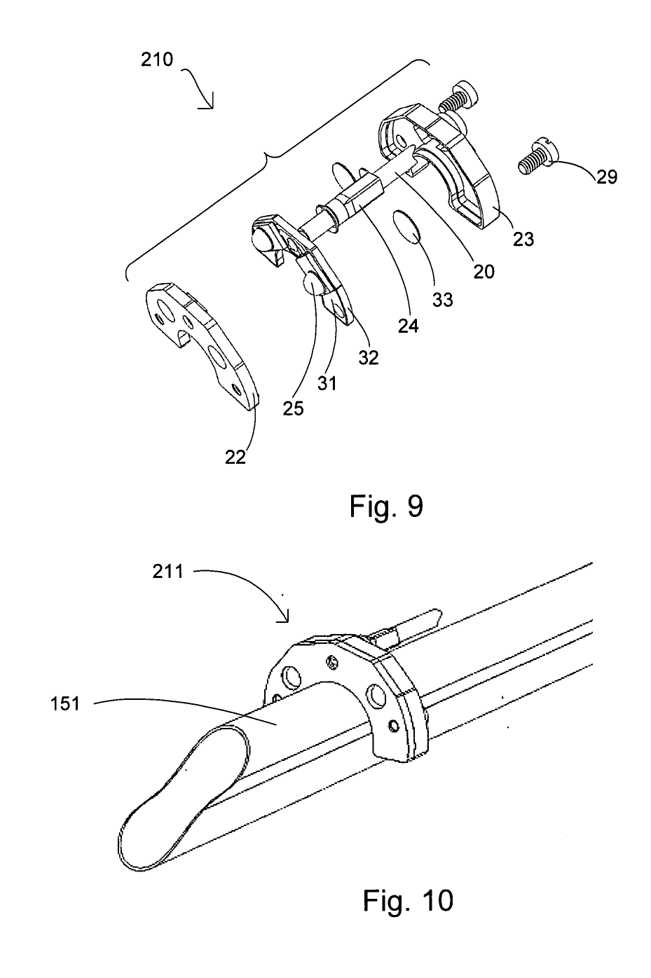

FIG. 9 is a perspective exploded view schematic illustration of the main assembly 210 of the first embodiment of the removable intraoral lighting device 200, according to the present invention. The illustration shows the elements already shown in previous illustrations, with the preferred addition of at least one and preferably a plurality of thermal pads 33, of which two are shown, which are designated to help with heat dispersal. Furthermore, the pads 33 also seal the LED's from humidity, such as that within the autoclave.

Other embodiments can be without such pads, have a different quantity of pads, or with pads of different shapes. The adhesive, which can also be injected into the main assembly 210, can also facilitate heat dispersal. An additional means for facilitating heat dispersal is a board frame 32 casing the board 31 along the sides of its narrow edges.

Board 31 is an element for holding the LED's with surface mount technology (SMT), inserted into the main assembly 210.

FIG. 10 is a perspective schematic illustration of a main assembly 211 of another embodiment of the removable intraoral lighting device, according to the present invention, connected to a suction tube 151.

The external geometrical shape of the main assembly 211 of the another embodiment is adapted to the lateral cross section of the suction tube 151 so that they can connect to each other efficiently.

One possible method of use of the removable intraoral lighting device according to the present invention includes the following main stages:
providing a dental tool;
providing a removable intraoral lighting device;
connecting the removable intraoral lighting device to the dental tool, freeing the dentist's and the dental assistant's hands;
inserting the dental tool into the patient's mouth;
activating the light of the removable intraoral lighting device;
performance of the treatment procedure by the dentist;
deactivation of the light;
removal of the dental tool from the patient's mouth,
separation of the removable intraoral lighting device from the dental tool; and
disinfection of the removable intraoral lighting device.

The dental tool can be, but is not limited to, a tool such as a saliva suction device, a suction tube, or a drill.

While the invention has been described with respect to a limited number of embodiments, it will be appreciated that many variations, modifications and other applications of the invention may be made.

What is claimed is:

1. A removable intraoral lighting device comprising:
(a) a main assembly enabling easy and strong clipping to a dental tool and for easy removal from said dental tool, said main assembly including:
(i) a front housing having at least one light hole;
(ii) a rear housing securely connected to said front housing;
(iii) a board disposed among said front housing and rear housing; and
(iv) at least one light source disposed upon said board, wherein an emitted light from said light source can pass through said light hole.

2. The removable intraoral lighting device of claim 1, further comprising:
(b) a wire operatively connected to said light source, enabling supply of electrical power from a power source.

3. The removable intraoral lighting device of claim 2, further comprising:
(c) a wire sleeve securely connected to said rear housing, wherein said wire is disposed inside said wire sleeve.

4. The removable intraoral lighting device of claim 2, further comprising:
(c) a clip disposed on said wire, said clip enabling easy and strong clipping to said dental tool and easy removal from said dental tool.

5. The removable intraoral lighting device of claim 1, wherein said front housing has at least one adhesive hole.

6. The removable intraoral lighting device of claim 1, further comprising:
(b) at least one clipping element mounted on said rear housing.

7. The removable intraoral lighting device of claim 1, further comprising:
(b) a board frame mounted on said board for adding strength to said board and for heat dispersal.

8. The removable intraoral lighting device of claim 1, wherein said rear housing has at least one fin for adding strength to said board and for heat dispersal.

9. The removable intraoral lighting device of claim 1, further comprising:
(b) at least one screw, wherein said screw fastens said rear housing to said front housing.

10. The removable intraoral lighting device of claim 1, further comprising:
(b) at least one thermal pad disposed at said board, for heat dispersal.

11. The removable intraoral lighting device of claim 1, further including:
(ii) at least one screw hole.

12. The removable intraoral lighting device of claim 11, further including:
(iii) at least one adhesive hole.

13. The removable intraoral lighting device of claim 1, further including:
(ii) a board frame.

14. The removable intraoral lighting device of claim 13, wherein said board is made of a PCB material.

15. The removable intraoral lighting device of claim 13, wherein said board is made of a flexible PCB material.

16. The removable intraoral lighting device of claim 1, wherein said light source is a LED.

17. The removable intraoral lighting device of claim 16, including at least two LEDs.

18. The removable intraoral lighting device of claim 16, further comprising:
(b) a lens disposed upon said front housing.

19. The removable intraoral lighting device of claim 16, further comprising:
(b) a transparent window disposed upon said front housing.

20. A removable intraoral lighting device comprising:
(a) a main assembly enabling easy and strong clipping to a dental tool and for easy removal from said dental tool, said main assembly including:
(i) a front housing having at least one light hole;
(ii) a rear housing securely connected to said front housing;
(iii) a board disposed between said front housing and rear housing; and
(iv) at least one light source disposed upon said board, wherein an emitted light from said light source can pass through said light hole;
(b) a wire operatively connected to said light source, enabling supply of electrical power from a power source;
(c) a wire sleeve securely connected to said rear housing, wherein said wire is disposed inside said wire sleeve;
(d) at least one clip disposed at said wire, said clip enabling easy and strong clipping to said dental tool and easy removal from said dental tool;
(e) at least one clipping element mounted on said rear housing;
(f) a board frame mounted on said board for adding strength to said board and for heat dispersal;
(g) at least one screw, wherein said screw fastens said rear housing to said front housing; and
(h) at least one thermal pad disposed at said board, for heat dispersal; wherein said front housing has at least one adhesive hole, and wherein said rear housing has at least one fin for adding strength to said board and for heat dispersal.

21. The removable intraoral lighting device of claim 20, further comprising:
(i) a lens disposed upon said front housing.

22. The removable intraoral lighting device of claim 20, further comprising:
(i) a transparent window disposed upon said front housing.

23. The removable intraoral lighting device of claim 20, wherein said dental tool is a saliva suction device.

24. The removable intraoral lighting device of claim 20, wherein said dental tool is a drill.

25. The removable intraoral lighting device of claim 20, wherein said dental tool is a suction tube.

26. The removable intraoral lighting device of claim 20, further comprising:
(i) a cooling pin disposed upon said rear housing.

27. The removable intraoral lighting device of claim 26, wherein said cooling pin has a circular cross section.

28. A removable intraoral lighting device adapted for being attachable to a dental tool, comprising:
(a) a main assembly comprising:
(i) a front housing having at least one light hole;
(ii) a rear housing securely connected to said front housing;
(iii) a board disposed among said front housing and rear housing;
(iv) at least one light source disposed upon said board, wherein an emitted light from said light source passes through said light hole, said at least one light source being capable of being independently operated.

29. A method of using removable intraoral lighting device providing effective light in the oral cavity while a dentist performs a treatment procedure, the method comprising the stages of:
(a) providing a dental tool;
(b) providing a removable intraoral lighting device; and
(c) connecting said removable intraoral lighting device to said dental tools.

30. The method of claim 29, further comprising the stages of:
(d) inserting said dental tool into the patient's mouth;
(e) activating said light of the removable intraoral lighting device; and
(f) performance of the treatment procedure by the dentist.

31. The method of claim 30, further comprising the stages of:
(g) deactivating of said light;
(h) removing said dental tool from the patient's mouth;
(i) separating said removable intraoral lighting device from said dental tool; and
(j) disinfecting said removable intraoral lighting device.

32. The method of claim 29, wherein said dental tool is a saliva suction device.

33. The method of claim 29, wherein said dental tool is a drill.

34. The method of claim 29, wherein said dental tool is a suction tube.

35. The method of claim 31, wherein said removable intraoral lighting device includes:
(a) a main assembly enabling easy and strong clipping to a dental tool and for easy removal from said dental tool, said main assembly including:
(i) a front housing having at least one light hole;
(ii) a rear housing securely connected to said front housing;
(iii) a board disposed between said front housing and rear housing; and
(iv) at least one light source disposed upon said board, wherein an emitted light from said light source can pass through said light hole;
(b) a wire operatively connected to said light source, enabling supply of an electrical power from a power source;
(c) a wire sleeve securely connected to said rear housing, wherein said wire is disposed inside said wire sleeve;
(d) at least one clip disposed at said wire, said clip enabling easy and strong clipping to said dental tool and easy removal from said dental tool;
(e) at least one clipping element mounted on said rear housing;
(f) a board frame mounted on said board for adding strength to said board and for heat removal;
(g) at least one screw, wherein said screw fastens said rear housing to said front housing; and
(h) at least one thermal pad disposed at said board, for heat dispersal; wherein said front housing has at least one adhesive hole, and wherein said rear housing has at lest one fin for adding strength to said board and for heat dispersal.
